(19) United States
(12) Patent Application Publication
(10) Pub. No.: US 2026/0059305 A1
(43) Pub. Date: Feb. 26, 2026

(54) LWM2M BASED USER EQUIPMENT FOR ACCESSING FIFTH-GENERATION CORE NETWORK USING NON-3GPP INTERWORKING FUNCTION

(71) Applicant: Itron, Inc., Liberty Lake, WA (US)

(72) Inventors: Ganesh K. Manika, Bellevue, WA (US); Galip Murat Karabulut, Vienna, VA (US); Brian D Waters, Angel Fire, NM (US)

(21) Appl. No.: 18/811,480

(22) Filed: Aug. 21, 2024

(51) Int. Cl. H04W 12/06; H04W 12/69; H04W 60/04

(52) U.S. Cl. CPC H04W 12/06; H04W 12/69; H04W 60/04

(57) ABSTRACT

Techniques for managing a communication session for a user equipment (UE) are described herein. The UE may include a device that does not include a radio modem used for communication over a core network (e.g., an IoT device, a laptop, a server, etc.). The UE may be provided credentials that may be securely stored and used to authenticate and establish a connection (e.g., via a N3IWF interface) with a telecommunications network. The credentials may uniquely identify the UE and include access capability to securely be modified as needed. The techniques discussed herein include utilizing a Lightweight Mobile-to-Mobile (LWM2M) client in the UE to communicate with the UE and provide credentials that may be stored by the UE as a list of encrypted custom objects.

### BACKGROUND

Mobile devices having radio modems (e.g., a 5G modem, a 4G modem, etc.) are typically provisioned with registration identification (ID) at the time of manufacturing such that when the mobile device is activated, the mobile device can register and connect with a core network that can authenticate the registration ID. Other types of devices that do not have radio modems (e.g., IOT devices, laptops, servers) may also access the core network via Non-3GPP Interworking Function (N3IWF), which provides a secure connection for user equipment (UE) to access fifth generation (5G) cellular-wireless access technologies. These UEs are often not provisioned with registration ID information recognizable by the core network, which can make it difficult for the UEs to access telecommunication technologies and for enterprise networks to access UEs that require software configuration (e.g., monitoring, reporting, troubleshooting, etc.).

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment in which an example device can connect to a telecommunications system that includes an example onboarding system to implement the techniques described herein.

FIG. 2 depicts an example system architecture for a fifth generation (5G) telecommunication network.

FIG. 3 depicts another example network environment in which an example user equipment can connect to a telecommunication system that includes an example (N3IWF) interface to implement the techniques described herein.

FIG. 4 depicts a messaging flow for establishing a communication session through an example onboarding system.

FIG. 5 depicts a flowchart of an example process for onboarding a UE to access a core network.

FIG. 6 depicts an example system architecture for a user equipment.

### DETAILED DESCRIPTION

This application relates to techniques for determining access for user equipment (UE) to a telecommunications system. In some examples, the UE may include a device that does not include a radio modem used for communication over a core network (e.g., an IoT device, a laptop, a server, etc.). A (N3IWF) interface may provide a secure connection for UEs to access a 5G core network (5GCN) over a non-3GPP access network. The UE may be provided credentials that may be securely stored and used to authenticate and establish a connection with the 5GCN. The credentials may uniquely identify the UE and include access capability to securely be modified as needed. The techniques discussed herein include utilizing a Lightweight Mobile-to-Mobile (LWM2M) client in the UE to communicate with the UE and provide credentials that may be stored by the UE as a list of encrypted custom objects. The LWM2M client of the UE may interact with a device management server (DMS) to manage the custom objects needed for storing the credentials and allow a network entity to access the credentials as needed via the DMS. By way of example, a camera application may operate on a mobile device as well as on a laptop. When the company and/or management service of the camera application needs to manage the camera application (e.g., update, troubleshoot, etc.), it may be difficult to access the camera application on the laptop, as opposed to the mobile device, which can be accessed via the core network. The techniques discussed herein enable on-boarding of these types of devices (e.g., devices without radio modems for accessing the core network) to a core network as well as service provisioning of the devices and/or applications operating on the devices.

The techniques may include the DMS (or system) associated with an access network (e.g., a non-3GPP network) receiving a request for access to a core network of a telecommunications system (e.g. a 5G system) from the UE and sending a request to an onboarding server to generate credentials (e.g., registration ID) for the UE. In some examples, the DMS may communicate with the UE via LWM2M and an LWM2M client stored on the UE. In some cases, the DMS may receive telemetry data from the UE that the DMS can utilize to determine that the UE was not provisioned with the necessary credentials to access the core network. For example, the telemetry data may include different types of identification information (e.g., application ID, client ID, hardware (HW) ID, virtual privacy network (VPN) ID, 5G object ID, library ID etc.). The DMS may determine that a particular type of information (e.g., registration ID for the core network) is missing from the telemetry data and determine that the UE requires access to the core network via a N3IWF interface. In some cases, once the DMS receives the telemetry data and determines that the UE requires credentials to access the core network, the DMS may send an instruction to the onboarding server to generate the credentials (e.g., registration ID). Once the credentials are generated, the DMS and/or the onboarding server may send the credentials to the UE via the LWM2M client and the UE may store the UE credentials as a list of custom objects. In some cases, LWM2M objects include functionalities the LWM2M client provides. The LWM2M client contains the object instances which is a collection of resources. A resource may be a single, typed, item of data which may exposed by a LWM2M client for consumption by an application.

In various examples, the UE may operate a number of different software applications that each require credentials to access the core network. In some cases, the telemetry data received by the DMS may include application information associated with each application operating on the UE and the DMS may forward the application information to the onboarding server. The onboarding server may generate credentials (e.g., subscription IDs, registration IDs, etc.) for each application operating on the device and provide the credentials to the UE via the LWM2M client such that each application can access and/or be accessed via the core network using its own credential information. In this way, if a particular application does not have the requisite credentials for accessing the core network, then the remaining applications will not be affected and continue to be accessible.

In some examples, once the UE and/or the applications have been onboarded with the core network, the telecommunications system may enable enterprise networks to access the applications stored on the UE via the core network. For example, the UE and/or the applications of the UE may authenticate with an AMF using EAP-AKA/5G-AKA protocols. Once authenticated, the UE and/or the applications may register with the N3IWF interface via an IP security (IPSec) tunnel as well as a user plane function (UPF) via a GPRS Tunneling Protocol-U (GTPU)/Generic Routing Encapsulation (GRE) tunnel. In some cases, the telecommunication system may receive application data from an enterprise network associated with one or more of the applications operating on the UE. In some cases, the application data may include an application identifier usable by the telecommunication system to identify which application is to be modified and/or otherwise accessed. In some examples, the application data may include an update and/or other modification data. Once the telecommunication system has received the application data and has identified the application, the telecommunication system may send the application data to the application and/or the UE.

The UE can represent an IoT device, a laptop, a server, a relay point, an unlicensed access point, a device that is able to wirelessly connect to an unlicensed access point to communicate with an access network (e.g., a non-3GPP network), or other entity of the access network. In some examples, the UE can represent an access point that is not owned and/or operated by a mobile network operator (MNO) of the telecommunication system and that is configured to communicate via Wi-Fi or other unlicensed access method. Thus, unlicensed access point may refer to a wireless access point that uses an unlicensed radio spectrum to establish a communication connection with other devices and networks, and unlicensed access method refers to a device using a communication channel that is established at least partially using an unlicensed radio spectrum to communicate with other devices or networks. The DMS can manage access for a UE including, in various examples, outputting options that enable the UE to connect to portions of the telecommunications network. By controlling access using the DMS as described herein, network capacity can be improved by sending fewer messages to downstream entities (e.g., a core network) which also prevents potential malicious activity from reaching such downstream entities.

In various examples, the DMS and/or the onboarding server may by parts of an onboarding system that represents firmware, hardware and/or software that generates, assigns, selects, or otherwise determines communication channel(s) available for use by the UE and generates credentials for the UE and/or applications to access those communication channels. The communication channel(s) can represent (or be associated with) a radio frequency (RF) channel, an optical channel, and/or a relay channel, just to name a few. For example, the relay channel can represent a mobile hotspot, or other network in which a first device relays signals and/or exchanges data with a second device using a tethering technique. A network policy associated with a mobile network operator (MNO) can, for example, determine which types of data (if any) can be transmitted using a particular communication channel (e.g., the relay channel). In various examples, a UE can send a message requesting a communication session with another device, the Internet, etc. Based on receiving the message, the onboarding system can transmit communication channel information and/or credential information to the UE independent of the UE and/or the onboarding system exchanging data over a core network. The communication channel information may, for instance, include one or more communication channels for connecting to various entities, as further described herein.

In some examples, the onboarding system may identify a device identifier (e.g., a P-Access-Network-Information (PANI), an International Mobile Equipment Identity (IMEI), Permanent Equipment Identifier (PEI), or other device identifier, associated with the UE usable for determining an authentication status for the UE. For example, the onboarding system can use the device identifier to verify whether the UE is registered with a mobile network operator to receive one or more services over a core network.

The access techniques described herein can improve a computing device and/or network in a variety of ways. Quality of service, network bandwidth, can be improved by managing access by an onboarding system free of requiring a core network to exchange data with the UE. For instance, messages from the UE can be prevented from reaching the core network thereby improving security (e.g., potential malicious activity by the unauthorized UEs) and/or be assigned a communication channel that protects the network by defining one or more communication channels for communicating, containing, or otherwise processing potentially malicious messages. The access techniques may also improve the telecommunications use of available network entities, processing resources, memory resources, and the like.

In various example, the techniques enable fewer messages to be transmitted over a network (e.g., the core network) by providing data to the UE using one or more access networks. By exchanging fewer messages to establish a communication session, additional bandwidth is available on the core network (e.g., for authorized or unauthorized emergency calls). Further, using the techniques described herein can improve transmission of message data from a UE using a telecommunications network by reducing latency otherwise caused by UEs accessing an AMF, IMS, core network, or other entity downstream from the onboarding system. Further description of the access techniques by the onboarding system can be found throughout this disclosure including in the figures below.

Though some examples are described in relation to an onboarding system, in various examples one or more computing devices, networks, or other entities may perform or otherwise be associated with the techniques described herein.

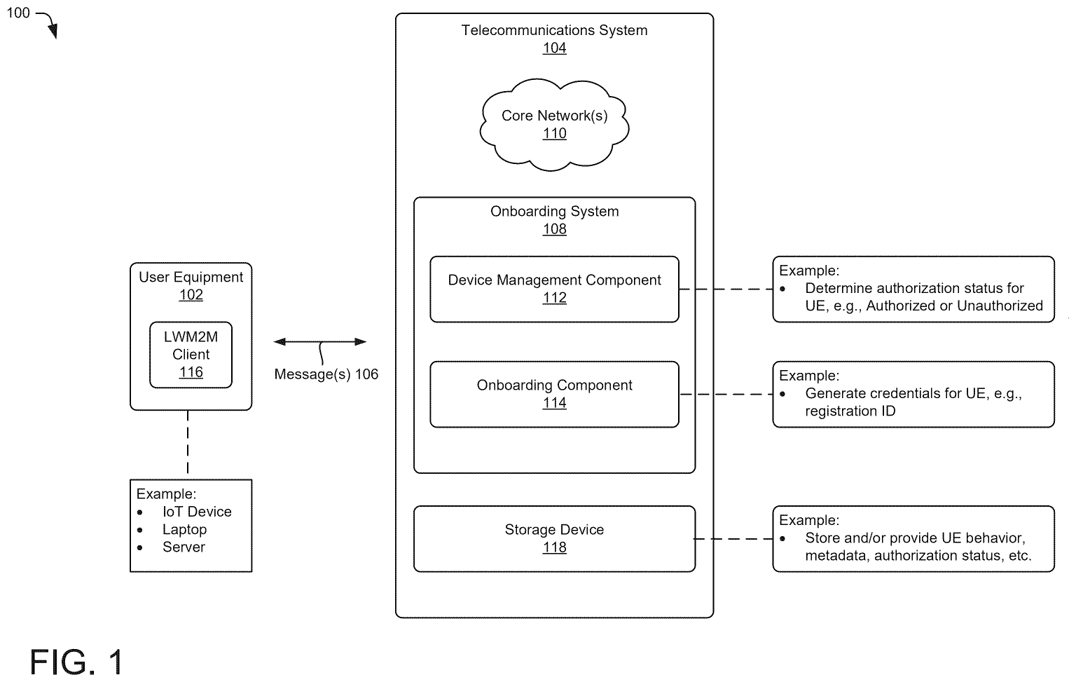

FIG. 1 depicts an example network environment 100 in which an example user equipment (UE) can connect to a telecommunications system that includes an example onboarding system to implement the techniques described herein. For example, a UE 102 (e.g., an IoT device, a laptop, a server, etc.) can initiate access to a telecommunications system 104 by sending a message 106 to an onboarding system 108 configured to onboard the UE 102 as well as enable service provisioning to the UE 102 via the telecommunications system 104. In various examples, the UE 102 can communicate with the onboarding system 108 independent of the UE 102 exchanging data with one or more core networks 110 (may also be referred to as the core network 110 or the core network(s) 110).

The UE 102 may represent any device that can connect to the telecommunication network, and in some examples may include a personal digital assistant (PDA), a personal computer (PC) such as a laptop, desktop, or workstation, a media player, a tablet, a gaming device, a smart watch, a hotspot, a Machine to Machine device (M2M), a vehicle (e.g., an autonomous vehicle, an unmanned aerial vehicle, airplane, boat, etc.), an Internet of Things (IoT) device, a server, or any other type of computing or communication device.

FIG. 1 depicts the onboarding system 108 comprising a device management component 112 and an onboarding component 114. FIG. 1 further depicts the telecommunications system 104 (e.g., a 5G system) comprising the onboarding system 108, the core network(s) 110, and a storage device 118. The onboarding system 108 (or component thereof) may, for example, exchange data with the storage device 118 (e.g., a memory, a database, etc.) to implement the access techniques described herein. The storage device 118 can represent, for example, a Unified Data Management (UDM) to manage user data and/or an Authentication Server Function (AUSF) to manage authorization for the UE 102 (e.g., in the 5G system shown). However, in examples when the core network is a different type, such as 4G, the storage device 118 can represent a Home Subscriber Server (HSS). Thus, the storage device 118 can represent various subscription management entities depending upon the example core network used to employ the techniques.

The message 106 from the UE 102 can indicate a request for a communication session and may, in some examples, be received via an access network prior to the message 106 reaching the core network 110. In some examples, the message 106 can represent a response (e.g., the communication channels available to the UE 102) from the onboarding system 108 to the UE 102. The core network 110 can represent a 5G network in various examples, though other core network types may also be used (e.g., past or future generation networks such as a sixth generation (6G) network).

The device management component 112 network may receive a request (e.g., via messages 106) for access to the core network 110 of the telecommunications system 104 from the UE 102 and may send a request to the onboarding component 114 to generate credentials (e.g., registration ID) for the UE 102. In some examples, the device management component 112 may communicate with the UE 102 via LWM2M and an LWM2M client 116 stored on the UE 102. In some cases, the device management component 112 may receive telemetry data from the UE 102 that the device management component 112 can utilize to determine that the UE 102 was not provisioned with the necessary credentials to access the core network 110. For example, the telemetry data may include different types of identification information (e.g., application ID, Client ID, HW ID, VPN ID, 5G Object ID, Library ID etc.). The device management component 112 may determine that a particular type of information (e.g., registration ID for the core network 110) is missing from the telemetry data and determine that the UE 102 requires access to the core network 110 via a N3IWF interface. In some cases, once the device management component 112 receives the telemetry data and determines that the UE 102 requires credentials to access the core network 110, the device management component 112 may send an instruction to the onboarding component 114 to generate the credentials (e.g., registration ID). Once the credentials are generated, the device management component 112 and/or the onboarding component 114 may send the credentials to the UE 102 via the LWM2M client 116 and the UE 102 may store the UE 102 credentials as a list of custom objects. In some cases, LWM2M objects include functionalities the LWM2M client 116 provides. The LWM2M client contains the object instances which is a collection of resources. A resource may be a single, typed, item of data which may exposed by a LWM2M client 116 for consumption by an application.

In various examples, the UE 102 may operate a number of different software applications that each require credentials to access the core network 110. In some cases, the telemetry data received by the device management component 112 may include application information associated with each application operating on the UE 102 and the device management component 112 may forward the application information to the onboarding component 114. The onboarding component 114 may generate credentials (e.g., subscription IDs, registration IDs, etc.) for each application operating on the device and provide the credentials to the UE 102 via the LWM2M client 116 such that each application can access and/or be accessed via the core network 110 using its own credential information. In this way, if a particular application does not have the requisite credentials for accessing the core network 110, then the remaining applications will not be affected and continue to be accessible because the UE 102 itself will not be dropped from the core network 110, only the unauthorized application.

The UE 102 can represent an IoT device, a laptop, a server, a relay point, an unlicensed access point, or other entity of an access network. In some examples, the UE 102 can represent an access point that is not owned and/or operated by a mobile network operator (MNO) of the telecommunication system 104 and that is configured to communicate via Wi-Fi or other unlicensed access method. The device management component 112 can manage access for a UE 102 including, in various examples, outputting options that enable the UE 102 to connect to portions of the telecommunications network. By controlling access using the device management component 112 as described herein, network capacity can be improved by sending fewer messages to downstream entities (e.g., a core network 110) which also prevents potential malicious activity from reaching such downstream entities.

In various examples, the device management component 112 and/or the onboarding component 114 may by parts of the onboarding system 108 that represents firmware, hardware and/or software that generates, assigns, selects, or otherwise determines communication channel(s) available for use by the UE 102 and generates credentials for the UE 102 and/or applications to access those communication channels. The communication channel(s) can represent (or be associated with) a radio frequency (RF) channel, an optical channel, and/or a relay channel, just to name a few. For example, the relay channel can represent a mobile hotspot, or other network in which a first device relays signals and/or exchanges data with a second device using a tethering technique. A network policy associated with a mobile network operator (MNO) can, for example, determine which types of data (if any) can be transmitted using a particular communication channel (e.g., the relay channel). In various examples, a UE 102 can send a message requesting a communication session with another device, the Internet, etc. Based on receiving the message, the onboarding system 108 can transmit communication channel information and/or credential information to the UE 102 independent of the UE 102 and/or the onboarding system exchanging data over a core network 110. The communication channel information may, for instance, include one or more communication channels for connecting to various entities, as further described herein.

Generally, the storage device 118 can provide functionality including storing metadata, network information, device information (e.g., authorization status, UE behavior, etc.), user information, and the like. In some examples, the storage device 118 can store, determine, and/or provide information associated with the UE 102 for use by a component.

In various examples, output data from a component of the onboarding system 108 can be stored in the storage device 118 for access at a later time. For example, the storage device 118 can receive activity associated with an access network, a core network, or the like, for storage and make such data available to a component for processing at a later time (e.g., to determine whether UE behavior is “normal”or “anomalous”).

In various examples, the communication channel information can include security information, bandwidth information, and/or latency information for establishing the communication session between the UE and another device or service (e.g., another UE, the PSAP, etc.).

To implement the techniques described herein, in various examples the telecommunications system 104 and/or the onboarding system 108 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 104 (e.g., a 5G system) can represent functionality to provide a communication channel for the UE 102, and can include one or more radio access networks (RANs), as well as one or more core networks linked to the RANs. For instance, the UE 102 can represent a UE to wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 104 is compatible to operate with other radio technologies including those of other service providers. Accordingly, the message(s) 106 from the UE 102 may originate with another service provider (e.g., a third-party) and be processed by the onboarding system 108 independent of the technolog(ies) or core network associated with the service provider.

While shown separately in FIG. 1, the device management component 112, the and the onboarding component 114 (and the functionality thereof) can be included in a single component of the onboarding system 108 and/or in another computing device (e.g., the UE 102 or another device associated with the telecommunications system 104). Further, the functionality associated with the onboarding system 108 can be included as hardware coupled to the UE 102.

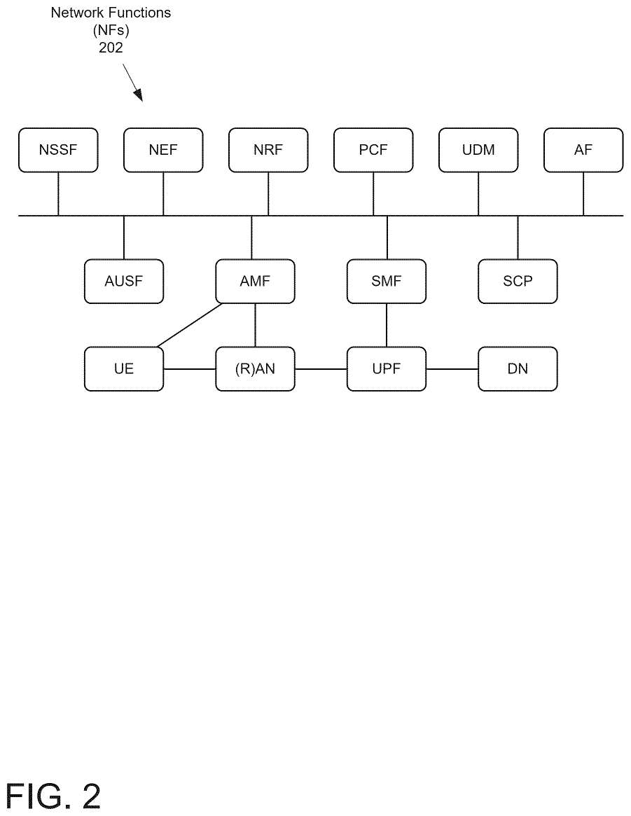

In some examples, the core network 110 can represent a service-based architecture that includes multiple types of network functions that process control plane data and/or user plane data to implement services for the UE 102. In some examples, the services comprise rich communication services (RCS), a VoNR service, a ViNR service, and the like which may include a text, a data file transfer, an image, a video, or a combination thereof. The network functions of the core network 110 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 110 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 110 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 110 can, in some examples, determine a connection between an IMS that manages a communication session for the UE 102, including sessions for short messaging, voice calls, video calls, and/or other types of communications. For example, the UE 102 and the IMS of the telecommunications system 104 can exchange Session Initiation Protocol (SIP) messages to set up and manage individual communication sessions. In some examples, the IMS of the telecommunications system 104 can generate a network slice to act as a communication channel for a voice communication, video communication, or other communication between the UE 102 and another computing device of a PSAP, emergency service provider, or the like.

Though some examples in FIG. 1 and elsewhere are described in association with a 5G telecommunication system, the techniques described herein can be used in other telecommunication system types include past generation and/or future generation telecommunication systems.

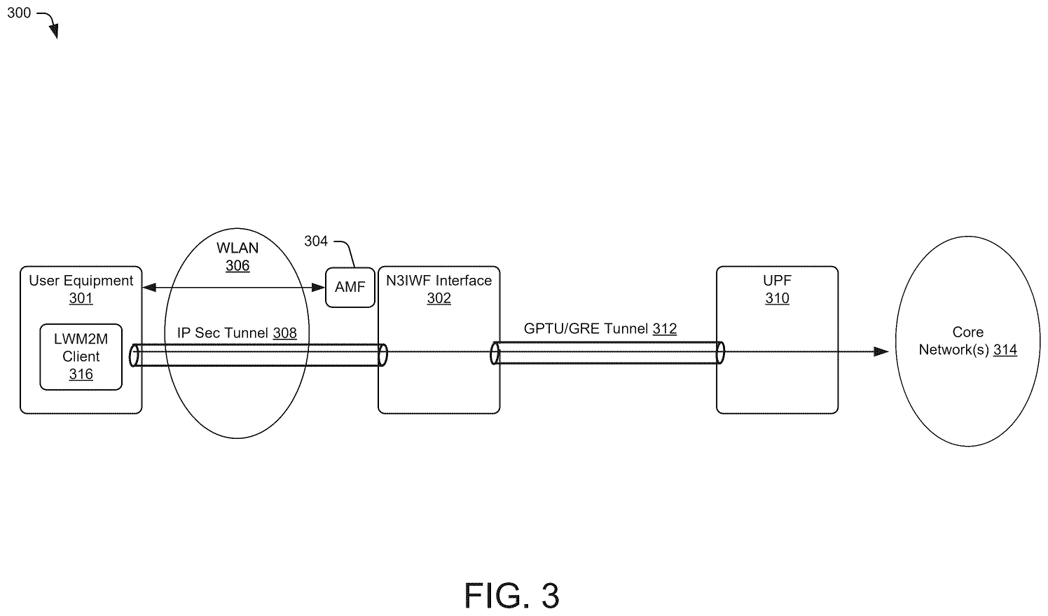

FIG. 3 depicts an example system architecture 300 for a fifth generation (5G) telecommunication network accessible by a N3IWF interface 302. In some examples, once a UE 301 (which may be the same or similar to the UE 102) and/or the applications have been onboarded with a core network 314 (which may be the same or similar to the core network 110), the telecommunications system may enable enterprise networks to access the applications stored on the UE 301 via the core network 314. For example, the UE 301 and/or the applications of the UE 301 may authenticate with an AMF 304 using EAP-AKA/5G-AKA protocols via WLAN 306. In some cases, the UE 301 may provide credentials stored in a LWM2M client 316. Once authenticated, the UE 301 and/or the applications may register with the N3IWF interface 302 via an IP security (IPSec) tunnel 308 as well as a user plane function (UPF) 310 via a GPRS Tunneling Protocol-U (GTPU)/Generic Routing Encapsulation (GRE) tunnel 312. In some cases, the telecommunication system may receive application data from an enterprise network associated with one or more of the applications operating on the UE 301. In some cases, the application data may include an application identifier usable by the telecommunication system to identify which application is to be modified and/or otherwise accessed. In some examples, the application data may include an update and/or other modification data. Once the telecommunication system has received the application data and has identified the application, the telecommunication system may send the application data to the application and/or the UE 301.

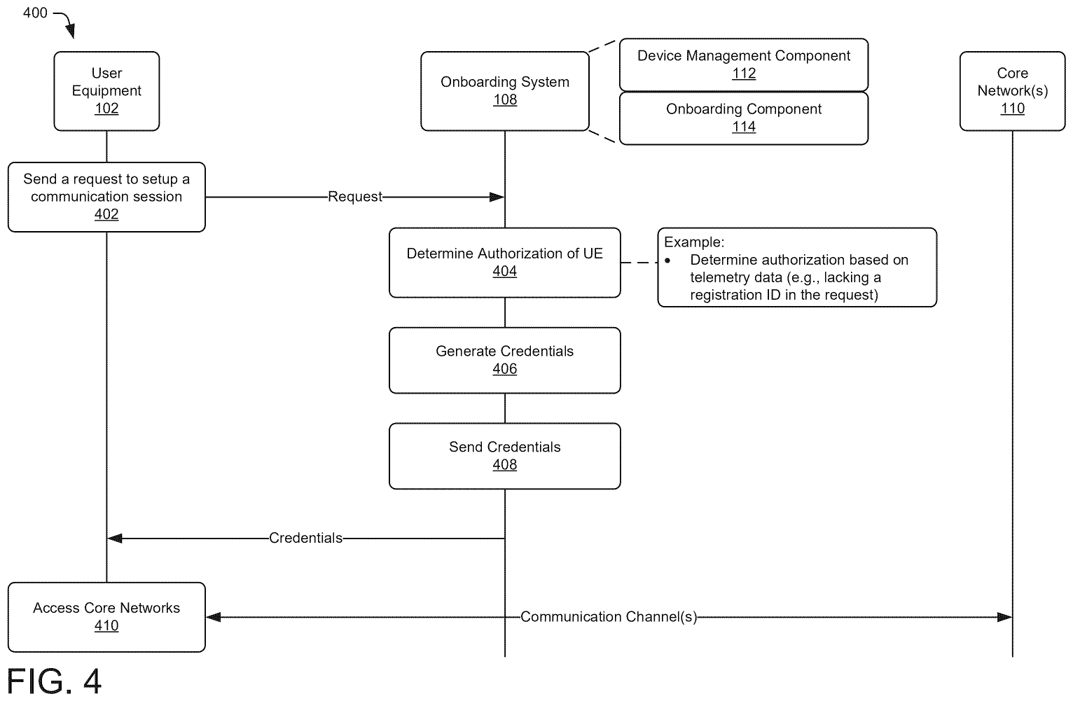

FIG. 4 depicts a messaging flow 400 for establishing a communication session through an example onboarding system. For example, the UE 102 of FIG. 1 and/or the UE 301 of FIG. 3 may exchange (e.g., send and/or receive) one or more messages with the onboarding system 108 to establish a communication session with another UE 102. In some examples, functionality associated with the onboarding system 108, the device management component 112, and or the onboarding component 114 can be included in a computing device, or other entity of the telecommunications system 104 that is configured to determine the communication session for the UE 102. In some examples, the access techniques can be performed by the UE 102 using hardware, software, and/or firmware coupled to, or associated with, the UE 102.

At 402, the UE 102 can send a request to setup a communication session over the core network 110 to the onboarding system 108 of the telecommunications system 104. For example, the UE 102 can send a call setup message, a test message, or other message usable to connect the UE 102 a service, another UE, and so on. The call setup request can include, for example, a message (e.g., the message 106) requesting a communication session with an IMS, an AMF, or other entity of the telecommunications system 104.

At 404, the onboarding system 108 can determine an authorization of the UE 102. For example, the device management component 112 can determine authorization status of the UE 102 based on information associated with the request, information stored in a storage device (e.g. the storage device 118), etc. In some examples, the device management component 112 may communicate with the UE 102 via LWM2M and an LWM2M client 116 stored on the UE 102. In some cases, the device management component 112 may receive telemetry data from the UE 102 that the device management component 112 can utilize to determine that the UE 102 was not provisioned with the necessary credentials to access the core network 110. For example, the telemetry data may include different types of identification information (e.g., application ID, Client ID, HW ID, VPN ID, 5G Object ID, Library ID etc.). The device management component 112 may determine that a particular type of information (e.g., registration ID for the core network 110) is missing from the telemetry data and determine that the UE 102 requires access to the core network 110 via a N3IWF interface.

At 406, the onboarding system 108 can generate credentials for the UE 102 to access the core network 110. For example, once the device management component 112 receives the telemetry data and determines that the UE 102 requires credentials to access the core network 110, the device management component 112 may send an instruction to the onboarding component 114 to generate the credentials (e.g., registration ID).

At 408, the onboarding system 108 can send the credentials to the UE 102. In various examples, once the credentials are generated, the device management component 112 and/or the onboarding component 114 may send the credentials to the UE 102 via the LWM2M client 116 and the UE 102 may store the UE 102 credentials as a list of custom objects. In some cases, LWM2M objects include functionalities the LWM2M client 116 provides. The LWM2M client contains the object instances which is a collection of resources. A resource may be a single, typed, item of data which may exposed by a LWM2M client 116 for consumption by an application.

At 410, UE 102 can establish a communication session with the core network 110. For example, referring to FIG. 3, once a UE 301 (which may be the same or similar to the UE 102) and/or the applications have been onboarded with a core network 314 (which may be the same or similar to the core network 110), the telecommunications system may enable enterprise networks to access the applications stored on the UE 301 via the core network 314. For example, the UE 301 and/or the applications of the UE 301 may authenticate with an AMF 304 using EAP-AKA/5G-AKA protocols via WLAN 306. Once authenticated, the UE 301 and/or the applications may register with the N3IWF interface 302 via an IP security (IPSec) tunnel 308 as well as a user plane function (UPF) 310 via a GPRS Tunneling Protocol-U (GTPU)/Generic Routing Encapsulation (GRE) tunnel 312. In some cases, the telecommunication system may receive application data from an enterprise network associated with one or more of the applications operating on the UE 301. In some cases, the application data may include an application identifier usable by the telecommunication system to identify which application is to be modified and/or otherwise accessed. In some examples, the application data may include an update and/or other modification data. Once the telecommunication system has received the application data and has identified the application, the telecommunication system may send the application data to the application and/or the UE 301.

Though the device management component 112 and the onboarding component 114 are illustrated in FIG. 4 individually, it is understood that the device management component 112 and the onboarding component 114 may be directly coupled to and/or integrated into a single component or computing device (including in some examples the UE). In some examples, functionality associated with the device management component 112 and the onboarding component 114 may be directly coupled to and/or integrated into the UE 102 of FIG. 1 and/or the UE 301 of FIG. 3.

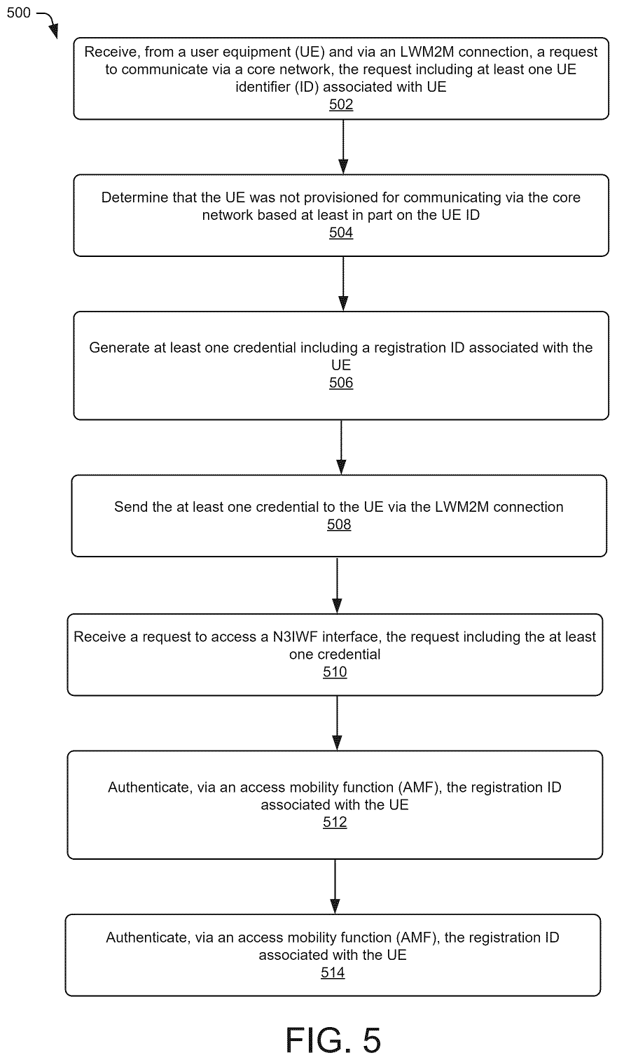

FIG. 5 depicts a flowchart of an example process 500 for onboarding a UE to access a core network. Some or all of the process 500 may be performed by one or more components in FIGS. 1-4, as described herein. For example, some or all of process 500 may be performed by the onboarding system 108 of FIG. 1.

At operation 502, the process may include receiving, from a user equipment (UE) and via an LWM2M connection, a request to set up access to a core network, the request including at least one UE identifier (ID) associated with UE. In some examples, the UE 102 can send a request to setup a communication session over the core network 110 to the onboarding system 108 of the telecommunications system 104. For example, the UE 102 can send a call setup message, a test message, or other message usable to connect the UE 102 a service, another UE, and so on. The call setup request can include, for example, a message (e.g., the message 106) requesting a communication session with an IMS, an AMF, or other entity of the telecommunications system 104.

At operation 504, the process may include determining that the UE was not provisioned for accessing the core network based at least in part on the UE ID. In some examples, the onboarding system 108 can determine an authorization of the UE 102. For example, the device management component 112 can determine authorization status of the UE 102 based on information associated with the request, information stored in a storage device (e.g. the storage device 118), etc. In some examples, the device management component 112 may communicate with the UE 102 via LWM2M and an LWM2M client 116 stored on the UE 102. In some cases, the device management component 112 may receive telemetry data from the UE 102 that the device management component 112 can utilize to determine that the UE 102 was not provisioned with the necessary credentials to access the core network 110. For example, the telemetry data may include different types of identification information (e.g., application ID, Client ID, HW ID, VPN ID, 5G Object ID, Library ID etc.). The device management component 112 may determine that a particular type of information (e.g., registration ID for the core network 110) is missing from the telemetry data and determine that the UE 102 requires access to the core network 110 via a N3IWF interface.

At operation 506, the process may include generating at least one credential including a registration ID associated with the UE. In some examples, the onboarding system 108 can generate credentials for the UE 102 to access the core network 110. For example, once the device management component 112 receives the telemetry data and determines that the UE 102 requires credentials to access the core network 110, the device management component 112 may send an instruction to the onboarding component 114 to generate the credentials (e.g., registration ID).

At operation 508, the process may include sending the at least one credential to the UE via the LWM2M connection. In some examples, the onboarding system 108 can send the credentials to the UE 102. In various examples, once the credentials are generated, the device management component 112 and/or the onboarding component 114 may send the credentials to the UE 102 via the LWM2M client 116 and the UE 102 may store the UE 102 credentials as a list of custom objects. In some cases, LWM2M objects include functionalities the LWM2M client 116 provides. The LWM2M client contains the object instances which is a collection of resources. A resource may be a single, typed, item of data which may exposed by a LWM2M client 116 for consumption by an application.

At operation 510, the process may include receiving, from the UE, a request to access the core network, the request including the at least one credential. In some examples, UE 102 can establish a communication session with the core network 110. For example, referring to FIG. 3, once a UE 301 (which may be the same or similar to the UE 102) and/or the applications have been onboarded with a core network 314 (which may be the same or similar to the core network 110), the telecommunications system may enable enterprise networks to access the applications stored on the UE 301 via the core network 314.

At operation 512, the process may include the UE based at least on the registration ID associated with the UE that is included in the at least one credential of the request to access. In some examples, the UE 301 and/or the applications of the UE 301 may authenticate with an AMF 304 using EAP-AKA/5G-AKA protocols via WLAN 306.

At operation 514, the process may include enabling the UE to access the core network via the core network. In some examples, once authenticated, the UE 301 and/or the applications may register with the N3IWF interface 302 via an IP security (IPSec) tunnel 308 as well as a user plane function (UPF) 310 via a GPRS Tunneling Protocol-U (GTPU)/Generic Routing Encapsulation (GRE) tunnel 312. In some cases, the telecommunication system may receive application data from an enterprise network associated with one or more of the applications operating on the UE 301. In some cases, the application data may include an application identifier usable by the telecommunication system to identify which application is to be modified and/or otherwise accessed. In some examples, the application data may include an update and/or other modification data. Once the telecommunication system has received the application data and has identified the application, the telecommunication system may send the application data to the application and/or the UE 301.

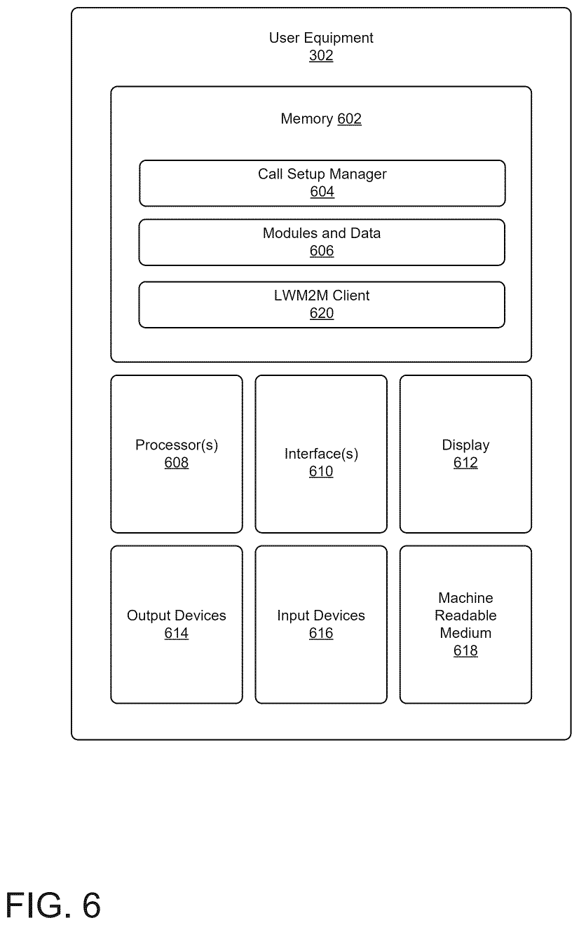

FIG. 6 depicts an example system architecture for the UE 301 (which may be the same or similar to the UE 102), in accordance with various examples. As shown, a UE 301 can have memory 602 storing a call setup manager 604, other modules and data 606, and a LWM2M client 620. A UE 301 can also comprise processor(s) 608, interfaces 610, a display 612, output devices 614, input devices 616, and/or a machine readable medium 618.

In various examples, the memory 602 can include system memory, which may be volatile (such as RAM), non-volatile (such as ROM, flash memory, etc.) or some combination of the two. The memory 602 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the UE 301. Any such non-transitory computer-readable media may be part of the UE 301.

The call setup manager 604 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The LWM2M client 620 may store credentials for accessing a core network as a list of custom objects. In some cases, LWM2M objects include functionalities the LWM2M client 620 provides. The LWM2M client 620 contains the object instances which is a collection of resources. A resource may be a single, typed, item of data which may exposed by a LWM2M client 620 for consumption by an application.

The other modules and data 606 can be utilized by the UE 301 to perform or enable performing any action taken by the UE 301. The modules and data 606 can include a UE platform, operating system, and applications, and data utilized by the platform, operating system, and applications.

In various examples, the processor(s) 608 can be a central processing unit (CPU), a graphics processing unit (GPU), or both CPU and GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing all computer applications stored in the memory 602, which can be associated with common types of volatile (RAM) and/or nonvolatile (ROM) memory.

The interfaces 610 can include transceivers, modems, interfaces, antennas, and/or other components that perform or assist in exchanging communications with the telecommunication network, a Wi-Fi access point, and/or otherwise implement connections with one or more networks.

The display 612 can be a liquid crystal display or any other type of display commonly used in UEs. For example, display 612 may be a touch-sensitive display screen, and can then also act as an input device or keypad, such as for providing a soft-key keyboard, navigation buttons, or any other type of interactive input. In some examples, the display 612 can represent a wearable device such as a headset for presenting and/or receiving data associated with a user. The output devices 614 can include any sort of output devices known in the art, such as the display 612, speakers, a vibrating mechanism, and/or a tactile feedback mechanism. Output devices 614 can also include ports for one or more peripheral devices, such as headphones, peripheral speakers, and/or a peripheral display. The input devices 616 can include any sort of input devices known in the art. For example, input devices 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, that embodies any one or more of the methodologies or functions described herein. The instructions can also reside, completely or at least partially, within the memory 602, processor(s) 608, and/or radio interface(s) 610 during execution thereof by the UE 301. The memory 602 and the processor(s) 608 also can constitute machine readable media 618.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein. For instance, techniques described in FIGS. 5 and 6 can be combined in various ways.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, from a user equipment (UE) and via an LWM2M connection, a request to set up access to a core network, the request including at least one UE identifier (ID) associated with UE;
determining that the UE was not provisioned for accessing the core network based at least in part on the UE ID;
generating at least one credential including a registration ID associated with the UE;
sending the at least one credential to the UE via the LWM2M connection;
receiving, from the UE, a request to access the core network, the request including the at least one credential;
authenticating the UE based at least on the registration ID associated with the UE that is included in the at least one credential of the request to access; and
enabling the UE to access the core network.

2. The method of claim 1, wherein the UE ID includes at least one of an application ID, a client ID, a hardware (HW) ID, a virtual privacy network (VPN) ID, a library ID, or a 5G object ID.

3. The method of claim 1, further comprising:
identifying a first application on the UE;
generating a first subscription ID associated with the first application;
identifying a second application on the UE; and
generating a second subscription ID associated with the second application.

4. The method of claim 1, further comprising:
receiving, from a third-party device, an update for an application operating on the UE;
identifying the application based at least in part on a subscription ID; and
sending the update to the application based at least in part on the subscription ID.

5. The method of claim 1, wherein enabling the UE access includes establishing a communication session between the UE and the core network that enables performing at least one of monitoring, reporting, or troubleshooting on an application operating on the UE.

6. The method of claim 1, further comprising obtaining one or more telemetry data from the UE, wherein the telemetry data indicates that the UE does not include the registration ID at a time of on-boarding.

7. The method of claim 6, further comprising, in response to determining that the UE does not include the registration ID at the time of on-boarding, collecting the UE ID from the UE and forwarding the UE ID to an onboarding server.

8. The method of claim 1, wherein the authenticating further includes authenticating the UE via an access mobility function (AMF) based at least on the registration ID associated with the UE using EAP-AKA/5G-AKA protocol.

9. The method of claim 1, wherein the at least one credential is stored by a LWM2M client of the UE as a list of custom objects.

10. A system comprising:
one or more processors; and
memory storing computer-executable instructions that, when executed by the one or more processors, cause the system to perform operations comprising:
receiving, from a user equipment (UE) and via an LWM2M connection, a request to set up access to a core network, the request including at least one UE identifier (ID) associated with UE;
determining that the UE was not provisioned for accessing the core network based at least in part on the UE ID;
generating at least one credential including a registration ID associated with the UE;
sending the at least one credential to the UE via the LWM2M connection;
receiving, from the UE, a request to access the core network, the request including the at least one credential;
authenticating the UE based at least on the registration ID associated with the UE that is included in the at least one credential of the request to access; and
enabling the UE to access the core network.

11. The system of claim 10, wherein the UE ID includes at least one of an application ID, a client ID, a hardware (HW) ID, a virtual privacy network (VPN) ID, a library ID, or a 5G object ID.

12. The system of claim 10, further comprising:
identifying a first application on the UE;
generating a first subscription ID associated with the first application;
identifying a second application on the UE; and
generating a second subscription ID associated with the second application.

13. The system of claim 10, further comprising:
receiving, from a third-party device, an update for an application operating on the UE;
identifying the application based at least in part on a subscription ID; and
sending the update to the application based at least in part on the subscription ID.

14. The system of claim 10, performing at least one of monitoring, reporting, or troubleshooting on an application operating on the UE.

15. The system of claim 10, further comprising obtaining one or more telemetry data from the UE, wherein the telemetry data indicates that the UE does not include the registration ID at a time of on-boarding.

16. The system of claim 15, further comprising, in response to determining that the UE does not include the registration ID at the time of on-boarding, collecting the UE ID from the UE and forwarding the UE ID to an onboarding server.

17. One or more non-transitory computer-readable media storing instructions executable by one or more processors, wherein the instructions, when executed, cause the one or more processors to perform operations comprising:
receiving, from a user equipment (UE) and via an LWM2M connection, a request to set up access to a core network, the request including at least one UE identifier (ID) associated with UE;
determining that the UE was not provisioned for accessing the core network based at least in part on the UE ID;
generating at least one credential including a registration ID associated with the UE; and
sending the at least one credential to the UE via the LWM2M connection.

18. The one or more non-transitory computer-readable media of claim 17, wherein the operations further comprise:
receiving, from the UE, a request to access the core network, the request including the at least one credential;
authenticating the UE based at least on the registration ID associated with the UE that is included in the at least one credential of the request to access; and
enabling the UE to access the core network.

19. The one or more non-transitory computer-readable media of claim 18, wherein the operations further comprise:
identifying a first application on the UE;
generating a first subscription ID associated with the first application;
identifying a second application on the UE; and
generating a second subscription ID associated with the second application.

20. The one or more non-transitory computer-readable media of claim 18 wherein the operations further comprise:
receiving, from a third-party device, an update for an application operating on the UE;
identifying the application based at least in part on a subscription ID; and
sending the update to the application based at least in part on the subscription ID.
